(19) United States
(12) Patent Application Publication
(10) Pub. No.: US 2016/0084442 A1
(43) Pub. Date: Mar. 24, 2016

(54) GAS SUPPLY DEVICE

(71) Applicant: Thomas Bickford Holbeche, Church Crookham (GB)

(72) Inventor: Thomas Bickford Holbeche, Church Crookham (GB)

(21) Appl. No.: 14/955,102

(22) Filed: Dec. 1, 2015

Related U.S. Application Data
(63) Continuation of application No. 14/357,667, filed on May 12, 2014.

(51) Int. Cl. F17C 7/00; F17C 13/06; F17C 13/00

(52) U.S. Cl. CPC F17C 7/00; F17C 13/002; F17C 13/06; F17C 2205/0323; F17C 2205/032; F17C 2221/03; F17C 2201/0109; F17C 2201/058; F17C 2203/0617; F17C 2223/0123; F17C 2223/035; F17C 2223/036; F17C 2270/0736

(57) ABSTRACT

A gas supply device includes a capsule for storing a gas under pressure, the capsule having a mouth; a closure at the mouth of the capsule in the form of a pierceable diaphragm; a cap fixedly and permanently secured to the capsule over the mouth; a passage through the cap permitting external access to the diaphragm; and a valve member in the passage, the valve member having a forward face carrying a diaphragm-piercing device, and being able to be urged by application of a diaphragm-piercing force against a bias of a spring to cause the diaphragm-piercing device to pierce the diaphragm and thereby release gas from the capsule into the passage, and a rearward face which on removal of the diaphragm-piercing force is biased by the spring into a valve-closing position in which gas is retained under pressure in the capsule.

This invention relates to a gas supply device, particularly one including a capsule for storing a gas under pressure, the capsule typically being of a size and weight that it can be readily held in the palm of a user's hand.

Such capsules are commonplace. Such a capsule conventionally has a closure at its mouth in the form of a diaphragm that can be pierced in order to release gas. Capsules containing carbon dioxide or nitrous oxide at a pressure typically in the order of 60 bar are well known. Such capsules are typically used in conjunction with a separate unit for piercing the diaphragm, the separate unit being incorporated into the device to which the gas is to be delivered or into a separate device which can mate with a unit in which the gas is to be used.

In a typical arrangement, disengagement of the capsule from the piercing unit results in the loss to the atmosphere of residual gas in the cylinder through the pierced diaphragm. An example of such an arrangement is, for example, disclosed in GB-A-971 161. A further disadvantage of such arrangements is that because the seal and piercing action are made essentially simultaneously, there is a risk that the diaphragm is pierced before a good face seal is effected, allowing high pressure gas to escape. Such escape is potentially hazardous. In addition, the escaped gas can penetrate screw threads between the capsule and the piercing unit and creates difficulty in tightening the capsule further due to the gas pressure acting on the threads.

According to the present invention there is provided a gas supply device comprising:

a capsule for storing a gas under pressure, the capsule having a mouth;

a closure at the mouth of the capsule in the form of a pierceable diaphragm;

a cap fixedly and permanently secured to the capsule over the said mouth;

a passage through the cap permitting external access to the diaphragm;

a valve member in the passage, the valve member having a forward face carrying a diaphragm-piercing device, and being able to be urged by application of a diaphragm piercing force against the bias of a spring to cause the diaphragm-piercing device to pierce the diaphragm and thereby release gas from the capsule into the passage, and a rearward face which on removal of the diaphragm-piercing force is biased by the spring into a volume-closing position in which gas is retained under pressure in the capsule.

A gas supply device according to the invention is therefore able to retain for at least a period of time gas in the capsule if the diaphragm-piercing force is withdrawn.

The cap typically has an external surface having a configuration enabling the gas supply device to be coupled to another device in which the gas is to be used. To this end, the said external surface of the cap conveniently has a screw thread.

A gas supply device according to the invention typically has a valve member which is connected to or integral with a valve spindle, to which spindle the diaphragm-piercing force can be applied, Typically, the arrangement is such that the act of coupling the gas supply device according to the invention to the gas using device causes the diaphragm-piercing force to be applied.

In one embodiment the spindle carries a seat for the spring, In this and other embodiments the spring may be a compression spring.

The rearward face of the valve member typically seats against an O-ring seal The O-ring seal may when the valve is closed is held under compression against an internal surface of the cap. In other embodiments, the rearward face of the valve member can carry an O-ring seal which is held under compression when the valve member seats against an internal surface of the cap.

In some embodiments of the gas supply device according to the invention, the forward face of the valve member is integral with the diaphragm-piercing device. In other embodiments, the forward face of the valve member carries a piercing needle. The piercing needle may be hollow or formed with at least one longitudinal groove to facilitate the passage of gas out of the capsule on the piercing of the diaphragm. If the said external surface of the cap which is to be coupled to another device in which the gas is to be used is formed with a screw-thread, the axial extent of that screw thread is conveniently greater than the distance travelled by the valve member from its diaphragm-piercing position to its valve-closing position. This enables the capsule to be securely coupled to the other device in which the gas is to be used before the diaphragm can be pierced.

The gas supply device according to the invention makes it possible to present a small effective area to the gas pressure thus facilitating coupling and uncoupling of the device to and from another device at higher working pressures. In addition, in embodiments in which the external surface of the cap has screw threads to engage with complementary screw threads in another device, the engaging threads are readily sealed from the capsule before the diaphragm is pierced.

In embodiments of the gas supply device according to the invention in which the valve member is connected to or integral with a spindle. the spindle does not protrude out of the passage even when the valve is in its closed position. The valve therefore has protection from damage in the event of the capsule being accidentally dropped.

A gas supply device according to the invention will now be described by way of example with reference to the accompanying drawings, in which:

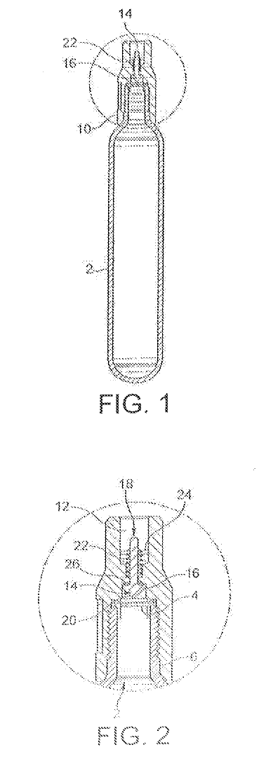

FIG. 1 is a general, schematic, sectional, side elevation of a gas supply device according to the invention;

FIG. 2 is a sectional side elevation of the head of the gas capsule shown in FIG. 1 prior to the piercing of its diaphragm seal;

FIG. 3 is a sectional side elevation illustrating the coupling of the cap of the gas supply device to a user device;

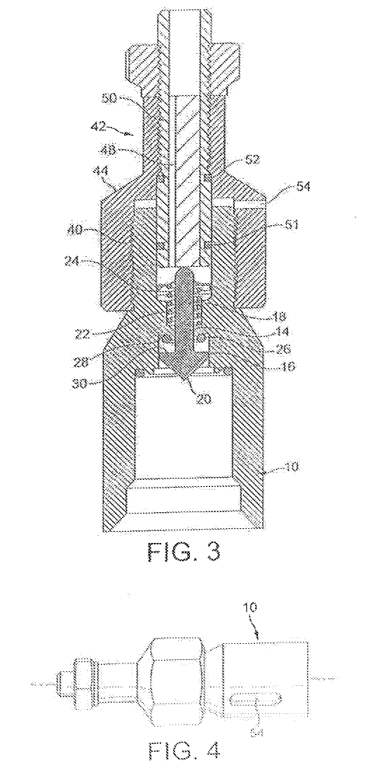

FIG. 4 is a side elevation, not in section, of the coupling member shown in FIG. 3;

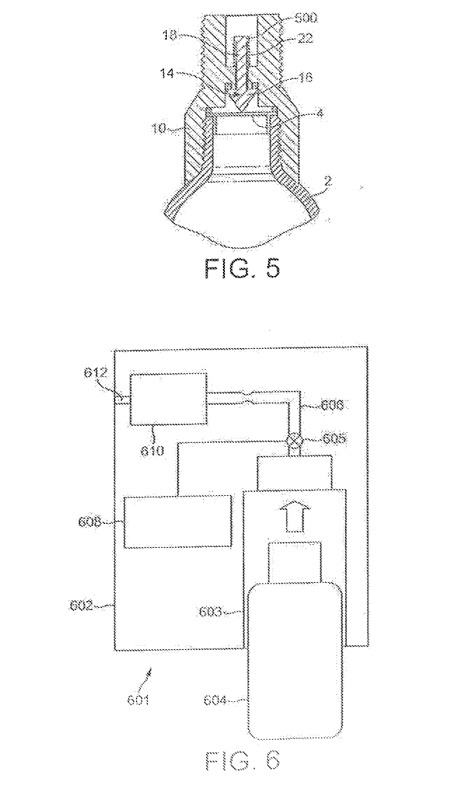

FIG. 5 is a schematic drawing of an alternative form of valve head to that in the gas supply device shown in FIGS. 1-3; and

FIG. 6 is a schematic drawing of an atmospheric pressure non-thermal gaseous plasma generating device which may be coupled to gas supply device according to the invention.

For purposes for ease of illustration, the head of the gas capsule is not shown in FIG. 3.

Referring to FIGS. 1-4, a gas supply device according to the invention comprises a gas capsule 2 for storing a gas under pressure. The gas capsule 2 has a closure 4 at its mouth in the form of a pierceable diaphragm 4 (see FIG. 2).

The capsule 2 is typically of a size and weight such that it can be held comfortably in the palm of the human hand. It typically has a water capacity in the range of 5-50 ml, The capsule 2 stores chosen gas under pressure. The storage pressure may be in the range of from under 25 bar to over 300 bar. The thickness and material of construction of the walls of the capsule 2 are selected so as to withstand the chosen storage pressure.

The capsule 2 is therefore typically formed of a suitable steel such as stainless steel or of aluminium. The capsule 2 shown in the drawings is of a conventional kind and may be made by known manufacturing processes.

The diaphragm 4 is typically formed of the same material as the capsule 2. It is typically welded in position once the capsule 2 has been charged with the chosen gas and the chosen pressure.

The capsule may be filled with any chosen gas. Some non-permanent gases may liquefy when subjected to the chosen storage pressure. Accordingly, the capsule may store the gas in liquefied state. If, however, the gas or gas mixture to be stored is a permanent gas, the gas will remain in gaseous state when subjected to the storage pressure.

The mouth of the capsule 2 is provided by a cylindrical protuberance 6 at the end of the capsule 2. The exterior surface of the cylindrical protuberance 6 is provided with a screw thread. It engages a complementary screw thread on a cap 10 having a passage 12 formed therethrough, the longitudinal axis of the passage 12 being coaxial with the longitudinal axis the capsule 2. The complementary screw threads are treated with a suitable adhesive such as sold under the trademark LOCTITE®. The adhesive cures at ambient temperature and has the effect of fixedly securing the cap 10 to the protuberance 6 of the capsule 2. A user of the gas supply device shown in FIGS. 1-4 is therefore not able solely by manual means to unscrew or separate the cap 10 from the capsule 2.

The cap 10 houses a diaphragm-piercing device 14 within the passage 12. The diaphragm-piercing device 14 is operable, as will be described below, to pierce or puncture the diaphragm 4 of the capsule 2 when it is desired to release gas from the capsule for the first time. Piercing device 14 comprises a head 16 integral with a spindle 18. In an alternative embodiment (not shown), the head 16 may be a separate part attached to the spindle 18. The forward face of the head 16 is formed with a pointed piercing tip 20.

The piercing device 14 is able to be urged forwards such that the piercing tip 20 breaks through the diaphragm 4 causing gas to be released from the capsule 2. Displacement of the piercing device 14 can be effected against the bias of a compression spring 22. The compression spring 22 is housed in the passage 12 and extends around the spindle 18. The spindle 18 is fitted with a spring retainer 24 of a “starlock” kind.

The head 16 of the piercing device 14 has a dual function. As well as providing the piercing tip 20, it acts as a valve member. Removal of a diaphragm-piercing force under the spindle causes the bias of the compression spring 22 to act against the spring retainer 24 and causes the piercing device to be withdrawn from the diaphragm 4 of the capsule 2 to travel backwards towards a resilent o-ring seal 26 retained on an inner surface 28 (see FIG. 3) of the cap 10. A rearward face 30 of the head 16 makes a sealing engagement with the o-ring 26 and thereby prevents gas from passing beyond the seal. Gas pressure acting on a forward face of the head 16 holds the head 16 against the o-ring seal 26. The piercing device 14 thus functions as part of a valve which is able to be closed when the diaphragm 4 has been pierced so as to prevent further passage of gas from the capsule 2 to a user device.

Referring particularly to FIG. 3, the external surface of the cap remote from the capsule 2 is provided with an external screw thread 40 to enable the cap 10 and hence the capsule 2 to be connected to a gas delivery device 42. The gas delivery device 42 has a hollow body 44 with an internal screw thread complementary to that of the screw thread 40. The device 42 can therefore be simply screwed on to the cap 10 of the capsule 2. The device 42 carries in its hollow body one end of a probe 50. The act of screwing the device 42 onto the cap 10 causes the probe 50 to bear against the spindle 18 of the piercing device 14 and urge the piercing device 14 forward such that its tip 20 pierces the diaphragm 4. The length of the screw thread 40 on the external surface of the cap 10 and the length of the complementary screw thread in the body 44 of the device 42 is greater than the distance travelled by the piercing device 14 from its valve-closing position to its diaphragm-piercing position. This enables the capsule 2 to be securely coupled to the device 42 before the capsule can be pierced. The probe 50 is provided with an internal gas passage 48 which communicates with a user device (not shown in FIGS. 1 to 4). Accordingly, when the piercing tip 20 fully penetrates the diaphragm 4 gas is able to flow from the capsule 2 past the o-ring seal 26 into the passage 48 to the user device. In order to minimise loss of gas over the external surface of the probe 50, resilient o-ring seals 51 and 52 are provided between the probe 50 and an internal surface of the cap 10 bounding the passage 12 and the body 44 of the connector device 42, respectively. In the event that any gas does leak past the seal 26, it may vent to the surrounding atmosphere through a slot 54 (see FIG. 4) formed in the connector device 42.

Once a chosen volume of gas has been delivered to the user, the cap 10 of the capsule 2 may be unscrewed from the gas delivery device 42, thus withdrawing the probe 50. As a result, the piercing device 14 travels away from the diaphragm 4 and its rearward face 30 makes sealing engagement with the o-ring seal 26, thereby preventing passage of gas from the capsule 2 past the head 16 of the piercing device 2. The gas is thus retained in the capsule 2 even though the diaphragm 4 has been pierced or punctured.

The screw thread 40 on the cap 10 and the complementary screw thread in the body 44 of the connector 42 may have specific complementary dimensions for a particular gas. Thus the capsule 2 may be dedicated to that gas. A capsule 2 storing a different gas would have a screw-thread 40 of different dimensions so that it could not be connected to a connector device 42 not designated for that particular gas.

If desired, a small filter or screen can be retained around the spindle 18 by the compression spring 22 so as to intercept any particles of the diaphragm 4 that may be formed during its rupture by the piercing tip 20.

Various modifications may be made to the gas supply device according to the invention. One such modification is shown in FIG. 5. In this modification, the spring retaining device 24 is omitted and the spindle 18 of the piercing device 14 is formed at its tail with an integral stop 500 which retains the compression spring 22. In another modification, the connector device 42 houses a pressure regulating valve (not shown) to reduce the pressure of the gas to a chosen value.

The gas supply device according to the invention may be used to store and deliver either a permanent or a non-permanent gas. In one example, it may be used to store and deliver a noble gas, for example, helium or argon, or a mixture of helium and argon, to a device for administering a non-thermal gaseous plasma to the oral cavity of a human being. FIG. 6 is a schematic diagram of a held device 601 for generating non-thermal gaseous plasma comprising a housing 602 which defines a docking station 603 receiving a gas supply device 604 according to the invention. In this embodiment, the gas supply device 604 comprises a 21 ml capacity gas capsule. The docking station 603 is provided with a connecting device (not shown) of the same kind as the connecting device 42 shown in FIG. 3. Full insertion of the gas supply device 604 in the docking station 603 causes the diaphragm of the gas capsule to be pierced and gas to be released from the gas capsule in the direction of the arrow. The docking station 603 communicates with a gas passage 606 in which the manually operable valve 605 is located. This valve 605 is normally closed so that on piercing the diaphragm of the gas capsule, none of the resulting release of gas can pass beyond the valve 605, The valve 605 is provided with a manually operable actuator 608, which can be operated to open the valve 605 to allow gas to pass therethrough. The passage 606 communicates with a cell 610 for generating a non-thermal gaseous plasma, typically at atmospheric pressure. The plasma generator cell 610 is provided with an applicator 612 which is able to be inserted into the oral cavity. Further information about the configuration and use of such devices in oral treatment is given in Patent Applications WO 2010/072997A, WO 2010/103262A and WO 2010/103263A, which are all incorporated herein by reference.

The gas supply device 604 may be removed from the docking station 603. As a result of such removal, the valve mechanism described with reference to FIGS. 1 to 5 closes, thereby retaining gas under pressure in the capsule.

What is claimed is;

1. A gas supply device comprising:
a capsule for storing a gas under pressure, the capsule having a mouth;
a closure at the mouth of the capsule in the form of a pierceable diaphragm:
a cap fixedly and permanently secured to the capsule over the mouth;
a passage through the cap permitting external access to the diaphragm; and
a valve member in the passage, the valve member having a forward face carrying a diaphragm-piercing device, and being able to be urged by application of a diaphragm-piercing force against a bias of a spring to cause the diaphragm-piercing device to pierce the diaphragm and thereby release gas from the capsule into the passage, and a rearward face which on removal of the diaphragm-piercing force is biased by the spring into a valve-closing position in which gas is retained under pressure in the capsule.

2. The gas supply device of claim 1, wherein the cap has an external surface of a configuration enabling the gas supply device to be coupled to another device in which the gas is to be used.

3. The gas supply device of claim 2, wherein the external surface of the cap has a screw thread.

4. The gas supply device of claim 1, further comprising a valve spindle to which the valve member is at least one of connected to or integral with the valve spindle, and against which the diaphragm-piercing force can be applied.

5. The gas supply device of claim 4, wherein the valve spindle further comprises a seat carried on said valve spindle for the spring.

6. The gas supply device of claim 1, wherein the spring comprises a compression spring.

7. The gas supply device of claim 1, further comprising an o-ring against which the rearward face of the valve member can be seated, the 0-ring being held under compression against an internal surface of the cap when the valve is in the closed position.

8. The gas supply device of claim 1, wherein the forward face of the valve member is integral with the diaphragm-piercing device. The gas supply device of claim 1, wherein the valve member further comprises a piercing needle carried on the forward face of said valve member.

10. The gas supply device of claim 9, wherein the piercing needle comprises at least one longitudinal groove to facilitate flow of gas from the capsule upon piercing of the diaphragm.

11. The gas supply device of claim 1, wherein the external screw-thread surface includes an axial extent being greater than a distance travelled by the valve member from its diaphragm piercing position to its valve closing position.

12. The gas supply device of claim 1, further comprising a filter or screen disposed at the passage and adapted to prevent transmission of solid particles formed by the piercing of the diaphragm.
